(19) United States
(12) Patent Application Publication
(10) Pub. No.: US 2019/0358678 A1
(43) Pub. Date: Nov. 28, 2019

(54) SNOW REMOVAL

(71) Applicant: Hal P. Greenberger, Natick, MA (US)

(72) Inventor: Hal P. Greenberger, Natick, MA (US)

(21) Appl. No.: 16/422,392

(22) Filed: May 24, 2019

Related U.S. Application Data
(60) Provisional application No. 62/676,449, filed on May 25, 2018.

(51) Int. Cl. B08B 1/00; B60S 3/04

(52) U.S. Cl. CPC B08B 1/005; B60S 3/045

(57) ABSTRACT

An apparatus for removing snow from vehicles incorporates an elongated flexible wall with gripping structures at either end of the flexible wall. The device can be used by an individual or a pair of individuals together. A single user bends the flexible wall into a generally U-shaped form, places the U-shaped flexible wall onto a vehicle surface and pulls the flexible wall toward themselves to remove snow. A pair of individuals extend the flexible wall so that it spans the vehicle width. The individuals stand on opposite sides of the vehicle where each individual grabs a gripping structure on one end of the flexible wall. The two individuals then pull the extended flexible wall along the vehicle length to remove snow. The flexible wall can roll up into a compact cylinder when not in use.

### CROSS REFERENCE TO RELATED APPLICATIONS

This application claims the benefit of U.S. Provisional Application No. 62/676,449, filed May 25, 2018, titled: “Snow Removal”, and is hereby incorporated by reference in its entirety.

### BACKGROUND

This disclosure relates to removing snow from exposed surfaces such as vehicles. Traditional snow brushes have a long handle with a straight brush attached. A user holds one end of the handle and moves snow with the brush that is attached to the other end. These devices are inefficient to use, especially when large amounts of snow need to be cleared. The user must make many passes over the same area to remove snow when the snow is deep. Long handle devices also can be difficult to store away or require the extra expense of telescoping handles to reduce their storage footprint.

### SUMMARY

All examples and features mentioned below can be combined in any technically possible way.

In one aspect, an apparatus for removing snow from an exposed surface includes a flexible wall, a first gripping structure coupled to a first end of the flexible wall and a second gripping structure coupled to a second end of the flexible wall, wherein the flexible wall is constructed and arranged so that a user can form it generally into a “U” shape.

Embodiments may include one of the following features, or any combination thereof. The exposed surface is part of a vehicle. The gripping structures are separate structures that are affixed to the flexible wall. The flexible wall is one of either continuous or piecewise linear. The apparatus includes a piecewise linear flexible wall which includes first and second side sections and a center section, wherein the first and second side sections are coupled to the center section. The first and second side sections are coupled to the center section via first and second hinge joints. The first and second hinge joints are formed from an elastomeric material. The first and second ends of the flexible wall are formed into a curved shape by the gripping structures. The flexible wall comprises stiffening ribs. The flexible wall is characterized by a height, wherein the height can vary as a function of position along the flexible wall. The flexible wall is constructed and arranged so that a user can roll up the flexible wall for storage. The flexible wall is rolled up about a height dimension into a cylindrical shape. The flexible wall is rollable into a cylindrical shape about a length dimension of the flexible wall. The flexible wall is constructed and arranged so that a user can fold up the flexible wall into a generally rectangular box shape for storage. The flexible wall material is foam. The flexible wall material is solid polymeric material. The solid polymeric material has a thickness of between 0.020 and 0.080 inches. The flexible wall is formed as a composite of two different materials. One of the composite materials is relatively softer and is arranged to contact surfaces to be cleared when the apparatus is used. The long edges of the flexible wall are beveled. The long edges of the flexible wall are chamfered. The long edges of the flexible wall are radiused.

The apparatus further includes first and second extension poles for removably coupling to the first and second gripping structures. The length of the flexible wall is in a range of between 2 feet and 5 feet. The extension poles comprise griping sections, wherein the extension poles are bent at an angle so that the gripping sections of the extension poles are oriented at an angle relative to a lengthwise centerline of the flexible wall.

The apparatus further includes a frost and ice removing structure coupled to one end of the first or second extension poles.

In another aspect, a method of removing snow from an exposed surface includes holding, by a user's first hand, a first gripping structure located near a first end of a flexible wall and holding by the user's second hand a second gripping structure located near a second end of the flexible wall, forming the flexible wall into a generally U-shaped form, extending the U-shaped flexible wall onto the exposed surface with the opening of the U facing the user and pulling the U-shaped form towards the user to remove snow from the vehicle.

Embodiments may include one of the following features, or any combination thereof. The first gripping structure incorporates a first extension pole, wherein the user grasps the first extension pole with their first hand, and the second gripping structure incorporates a second extension pole, wherein the user grasps the second extension pole with their second hand.

In another aspect, a method of removing snow from a vehicle comprises holding by a first user a first gripping structure located near a first end of a flexible wall, the first user situated alongside a first side of the vehicle, holding by a second user a second gripping structure located near a second end of the flexible wall, the second user situated alongside a second side of the vehicle opposite the first side, extending the flexible wall across the vehicle surface to span the width of the vehicle, and pulling the flexible wall along a portion of the length of the vehicle across the vehicle surface by the first and second users, to remove snow from the vehicle.

In another aspect, an apparatus for removing snow from a vehicle includes a flexible wall, a first coupling structure coupled to a first end of the flexible wall and a second coupling structure coupled to a second end of the flexible wall, wherein the flexible wall is constructed and arranged so that a user can form it into generally a U shape.

### BRIEF DESCRIPTION OF THE DRAWINGS

FIG. 1 is a perspective view of a prior art snow brush.

FIG. 2 is a perspective view of a prior art snow brush.

FIG. 3A is a perspective view of an example snow wiper.

FIG. 3B is a perspective view of an example snow wiper with a rear section having increased height.

FIG. 4A is a perspective view of an example snow wiper with creases to pre-bias its shape.

FIG. 4B is a perspective view of an example snow wiper with piecewise linear flexible wall with three sections joined together by hinges.

FIG. 4C is a top view of the piecewise linear flexible wall of FIG. 4B folded for storage.

FIG. 5A is a perspective view of an example snow wiper having one material used for side sections and a second material used for a center section.

FIG. 5B is a perspective view of the example snow wiper of FIG. 5A folded up for storage.

FIG. 5C is a perspective view of an example snow wiper with a center section having vertical stiffening ribs.

FIG. 6 is a perspective view of an example snow wiper having extra material added to form gripping structures.

FIG. 7A is a perspective view of an example snow wiper where the ends of a flexible wall are folded back onto the flexible wall, to form gripping structures.

FIG. 7B is a perspective view of an example snow wiper where the ends of a flexible wall are folded back onto the flexible wall, to form gripping structures.

FIG. 8A is a perspective view of an example snow wiper where tab structures in the ends are used to form gripping structures.

FIG. 8B is a perspective view of one end of the example snow wiper of FIG. 8A with a tab end fed through slots in the flexible wall to form a gripping structure.

FIG. 9 is a perspective view of an example snow wiper where gripping structures in the ends are formed integrally with the flexible wall of the snow wiper.

FIG. 10A is a perspective view of an example snow wiper with reduced wall thickness near the bottom edge.

FIG. 10B is a perspective view of an example snow wiper with a soft edge trim piece fit to the bottom edge of a stiffer material used as part of the flexible wall.

FIG. 10C is a perspective view of an example snow wiper with a softer material laminated to a stiffer material to form the flexible wall.

FIG. 11 is a perspective view of an example snow wiper rolled up for storage.

FIG. 12A is perspective view of a snow wiper placed on a vehicle surface for use by a single user.

FIG. 12B is perspective view of a snow wiper placed on a vehicle surface for use by a pair of users.

FIG. 13 is a perspective view of an example snow wiper with one end exploded to show how the flexible wall, gripping structures and extensions handles fit together.

FIG. 14A is a perspective view of an example snow wiper showing a pair of extension poles coupled to one end of a flexible wall of the snow wiper.

FIG. 14B is a perspective view of an example snow wiper showing a single bent extension pole coupled to one end of a flexible wall of the snow wiper.

FIG. 15 is a perspective view of an example extension pole with a frost and ice scraper attached to one end, for use with a snow wiper.

FIG. 16A is a perspective view of an example snow wiper in an extended state.

FIG. 16B is a perspective view of the example snow wiper of FIG. 16A in a closed state for storage.

FIG. 16C is a cut away view showing a portion of the snow wiper of FIG. 16A.

### DETAILED DESCRIPTION

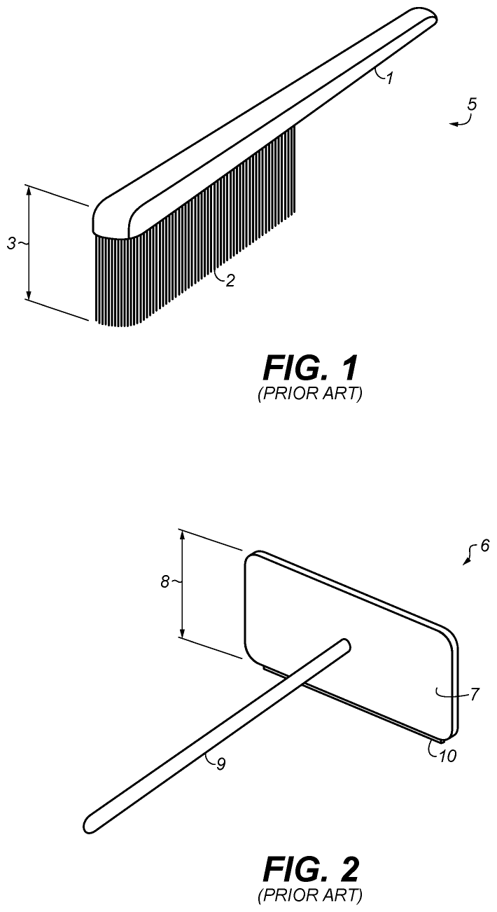

Traditional prior art snow brush 5 for removing snow is depicted in FIG. 1. Snow brush 5 has an elongated handle 1 with bristles 2 attached to one end. Bristles 2 are formed in a dense arrangement. The overall height 3 of snow brush 5, which includes the height of bristles 2 and handle 1, is generally less than 3 inches and is more typically closer to 2 inches. When the snow accumulation height is greater than the overall height, not all the snow present will be cleared away when an area is swept by the brush. As the brush is moved, the brush slides under the snow that sits higher than the top of the brush, and the snow above the brush is not cleared. Snow that accumulates in front of the brush pushes upward over the top and around the sides of the brush and is also left behind. Numerous passes are required before all the snow is cleared.

A second prior art snow brush is depicted in FIG. 2. Semi-rigid plate 7 of snow brush 6 is affixed to the end of elongated handle 9. Edge 10 of semi-rigid plate 7 is arranged to contact a vehicle surface. The height of semi-rigid panel 7 may be as high as 6 inches. Prior art snow brush 6 suffers from some of the same problems as prior art snow brush 5 of FIG. 1. When the semi-rigid panel is pulled across a surface of a vehicle to remove snow that has accumulated on the vehicle outer surface, snow pushes around the sides and over the top of the semi-rigid wall and is left behind, requiring additional passes to clear an area.

To address problems of prior art snow brushes and brooms that allow snow to pass around the sides or over the top of the brush/broom, example snow wipers disclosed herein incorporate an elongated flexible wall that solves the problems by extending a wall to encircle an area covered in snow. A flexible wall has a shape that can be easily altered by a user. More specifically, it should be understood that a “flexible” wall is a wall that can be formed into a generally “U-shaped” form by a user.

A flexible wall can be folded up or rolled up by a user into a more compact envelope for storage. A flexible wall can be of a continuous type. When a user inputs forces to ends of a continuous flexible wall, bending that occurs is generally distributed continuously along the wall. A flexible wall can be of a piecewise linear type where a number of relatively less-stiff joints are coupled between relatively stiffer wall sections. When a user inputs forces to the ends of a piecewise linear flexible wall, bending occurs primarily in the joint locations.

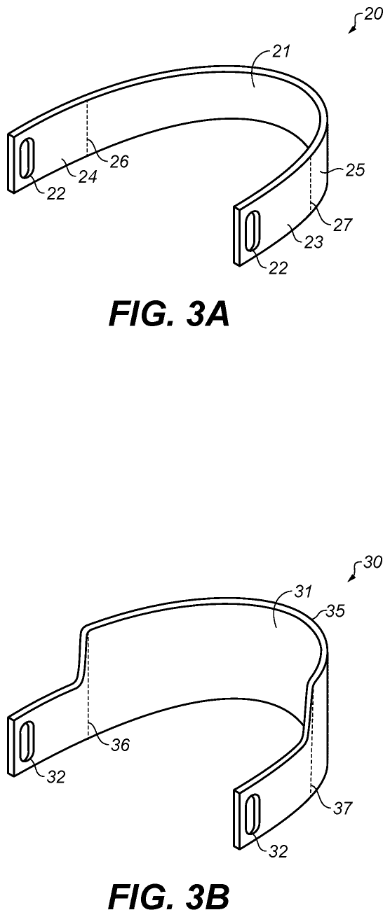

One non-limiting example snow wiper is depicted in FIG. 3A. Snow wipers can be used to remove snow from surfaces covered in snow, such as vehicle exterior surfaces or other exposed surfaces such as the roof of a semi tractor trailer or the roof of a dwelling or building. Snow wiper 20 is formed from elongated flexible wall 21. The length of the elongated flexible wall 21 is generally between 2 ft. and 12 ft. Smaller lengths result in devices that do not reach sufficiently far across larger vehicles, and larger lengths become more difficult for one person to use. However, lengths are not limited to a maximum of 12 ft. or a minimum of 2 ft, and snow wipers longer than 12 ft. or shorter than 2 ft. are also contemplated herein.

A snow wiper may combine a flexible wall with extension handles that couple to structures affixed to the ends of the flexible wall. Any physical structure added to the ends of the flexible wall that allows a user to more easily grasp the flexible wall when extension handles are not present is considered here to be a gripping structure, whether or not specific features are added to the structure for the specific purpose of aiding a user to grip the flexible wall. Coupling structures located at ends of a flexible wall to accommodate extension handles will then also generally act as gripping structures. It should also be noted that gripping structures as the term is used here are not constrained to be physical structures added to a flexible wall. In numerous examples disclosed here, the absence of a physical structure, i.e. a hole or penetration in the flexible wall, also is considered to be a gripping structure.

Extension handles extend the reach of the snow wiper beyond just the length of the flexible wall. Extension handles are useful for removing snow from the roof of a vehicle, or from the roof of a semi tractor trailer or a roof of a dwelling or building. Extension handles can be used with flexible walls of any desired length. However, it has been found that flexible wall lengths of between 2 and 5 ft work well with extension handles. While flexible walls shorter than 2 ft or longer than 5 ft may work, flexible walls shorter than 2 ft. or longer than 5 ft. are less practical.

In one non-limiting example, a snow wiper combines a flexible wall that is 36″ in length with a pair of extension handles. The extension handles can be of any desired length. For ease of storage in a vehicle, extension handles for a snow wiper configured to remove snow from vehicle surfaces may be 24″ in length. Multiple extension handles can be snapped together to increase overall reach. Individual extension handles for snow wipers configured to remove snow from a building or dwelling roof may be 8 to 10 ft or more in length, and multiple sections may snap together to further increase reach. Example snow wipers disclosed herein are not limited in the length of extension handles used or in the number of extension handles used. Extension handles may snap together in a straight line or may snap together at a relative angle. While any angle less than 90 degrees is contemplated herein, angles between approximately 15 and 30 degrees are useful for a snow wiper used for a vehicle with a tall roof, to increase the reach of a user across the top of the roof. Extension handles are described further in a subsequent section.

The max. allowable passenger vehicle width in California is 8.5 ft. (see http://leginfo.legislature.ca.gov/faces/codes_displayText.xhtml?lawCode=VEH&division=15.&ti tle=&part=&chapter=2.&article). In one non-limiting example, the length of the flexible wall is between 2 feet and 8.5 feet. In one non-limiting example, it has been found that 5 ft. is a good practical length for the flexible wall without additional extension poles being used. As described earlier, In one non-limiting example, it has been found that a good practical length for a flexible wall incorporating gripping structures at each end of the flexible wall that can couple to extension handles as described above and can also be directly gripped by a user is 3 ft.

It should be noted that although the discussion of length of the flexible wall above is made in reference to snow wiper 20 of FIG. 3A, the discussions of length (and discussions of height and wall thickness which follow) are applicable to all of the example snow wipers disclosed herein, including snow wipers with both continuous and piecewise linear flexible walls. Also, for ease of description, the elongated flexible wall described above will be referred to as simply a “flexible” wall.

The height of flexible wall 21 can be whatever is desired by the manufacturer. Typically, the height of flexible wall 21 will be chosen to be greater than or equal to 2 inches. The height also may also be less than or equal to 12 inches. Flexible wall heights below 2 inches are not of significant benefit, while wall heights greater than 12 inches may have some benefit in cases of extreme snowfall accumulation but the limited benefit must be weighed against increased costs and more difficulty in storing when not in use. In one non-limiting example, the height of the flexible wall is between 3 inches and 10 inches. In general, flexible walls with larger wall heights work better when larger snow accumulations need to be removed but using a larger wall height uses more material which increases cost, and snow wipers with larger flexible wall heights take up more space when stowed away. It has been found that 6 inches is a good practical height for the flexible wall for the example snow wipers disclosed herein. Because snow wipers can be formed into a “U” shape which surrounds snow to be removed on 3 sides, a snow wiper can effectively remove snow that has accumulated above the flexible wall height without the snow falling over the flexible wall. The “U” shape tends to move the entire base of snow that sits within the “U” at the same time when cleared.

Example snow wipers disclosed herein have a flexible wall with a length to height ratio. Practical example snow wipers have a length to height ratio of between 1 and 30, and preferably between 4 and 25. In one non-limiting example, a flexible wall of a snow wiper has a length of at least 24″ and a length to width ratio between 2 and 20.

In one non-limiting example depicted in FIG. 3B, the height of flexible wall 31 of snow wiper 30 varies as a function of length of the flexible wall. The height of a central portion 35 of the flexible wall may be made higher than the height of end portions. This allows the snow wiper to be more effective with larger snow accumulations while reducing the amount of material used to form the flexible wall. In one non-limiting example, end portions of the flexible wall may have a first height, which may be 4 inches, and a central portion of the flexible wall may have a second height, which may by 8 inches or more. The height of the flexible wall may smoothly transition from the height of the end sections to the height of the central section. It should be noted that the heights of end portions and central portion are not limited to 4 inches and 8 inches, and any height for these sections is contemplated herein.

The shape of the flexible wall, of example snow wipers disclosed herein, when placed against a vehicle surface can be altered by the user. The user can change the shape by changing the position of their hands that hold the gripping structures coupled to the ends of the flexible wall (by altering the height of ends of the flexible wall above the vehicle surface, by altering the relative angle of the flexible wall with respect to the surface, or by altering the spacing of the ends, etc.), while also altering the amount of force they apply and the direction the force is applied. By varying these parameters, the bottom edge of the flexible wall can be caused to change shape to better match the contour of the underlying vehicle surface. It is possible for the user to deform the flexible wall so that virtually the entire bottom edge of the flexible wall can contact the vehicle while the user moves the device over the vehicle surface. In some examples as will be described in more detail later, a soft gasket lip (for example an extruded rubber, elastomer or TPE material (for example, a material similar to materials used for windshield wiper blades) may be applied to the bottom edge of the flexible wall to facilitate edge contact with the vehicle surface.

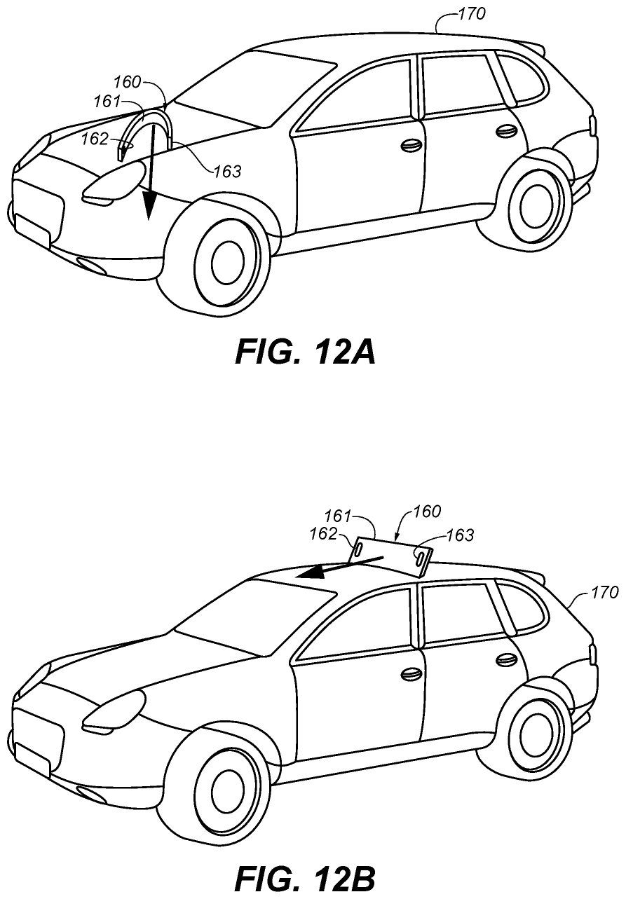

When example snow wipers are used by a single individual, the user grasps gripping structures at each end of the flexible wall and bends the flexible wall generally into a U shape. The user then places the U-shaped snow wiper against the vehicle surface and pulls it along the surface to remove snow. If two users are present, a snow wiper can be extended across the width of the vehicle, where a user on a first side of the vehicle grasps one gripping structure and a second user on the other side of the vehicle grasps a second gripping structure. The two users then pull the extended flexible wall along the vehicle length to remove snow. Operation of snow wipers is described in more detail with respect to FIGS. 12A and 12B.

When formed into a “U” shape (as the case for single person use), in one non-limiting example the flexible wall can be thought of as a combination of three sections. Depicted in FIG. 3A, center section 25 forms the curved bottom portion of the “U” shape and is coupled between end sections 23 and 24 which form the sides of the “U” shape. Dotted lines 6 and 7 demarcate transitions between the sections. Note that the flexible wall 21 of wiper 20 is continuous and there are no physical structures located at transitions 26 and 27 (though in some examples described later, physical differences are present in these locations). The distinction between straight and curved sections is somewhat arbitrary in this example but is useful for understanding how example snow wipers function. When placed on a vehicle surface covered with snow, the “U” shaped flexible wall will surround snow covering a section of the vehicle on 3 sides (the 4^{th} side is open and is where the snow is removed). Prior art devices typically have only a rear section, no side sections, and are also straight, not curved. Adding the side sections to the rear section as done in example snow wipers disclosed herein keeps snow from spilling around the sides of the rear section, as occurs for prior art snow brushes or brooms (as shown in FIGS. 1 and 2). By coupling side sections to ends of the center section, essentially all of the snow located within the interior of the “U” shape is removed from the vehicle with a single pass. Substantially more snow will be cleared away by an example snow wiper device having side walls 23 and 24 coupled to (center section) 25 than would be cleared away if side walls 23 and 24 were not present.

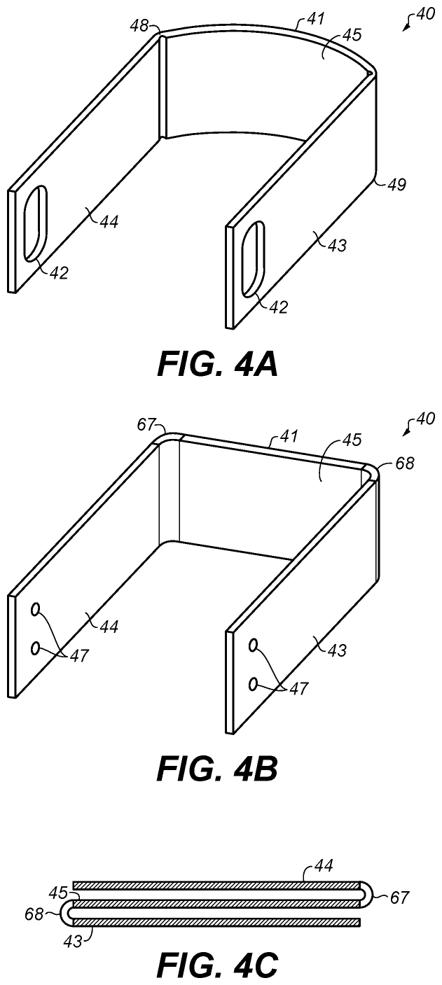

It can be useful to have more control over the shape of the flexible wall in use. In one non-limiting example, the flexible wall is constructed and arranged so as to bias the wall into a desired shape. Locations are constructed on the flexible wall to preferentially bend when stress is applied to the wall, such as occurs when user wishes to form the flexible wall into a general “U” shape for use. More bending occurs in these preferential bending locations than in other locations along the flexible wall. Referring to FIGS. 3A, 3B and 4A, transition locations 26, 27, 36 and 37 along walls 21, 31 of FIGS. 3A and 3B can be locally stressed to form creases, such as creases 48 and 49, in flexible wall 41 of snow wiper 40 shown in FIG. 4A. The creases act as preferential bending locations to aid the flexible wall in forming a desired shape.

In one non-limiting example, local stress sufficient to exceed the elastic limit of the flexible wall material is applied to locations (such as transition locations 26, 27, 36, 37, 48 and 49) along the flexible wall (such as flexible walls 21, 31, 41 or other flexible walls disclosed herein), to cause permanent deformation of the flexible wall. Preferential bending locations 48 and 49 provide physical structures that demarcate transitions between the side wall sections 43 and 44, and rear (center) wall section 45. The local regions of the flexible wall 41 near preferential bending locations 48 and 49 are characterized by a much smaller radius of curvature compared to the radius of curvature of the flexible wall away from these locations, when the wiper is curved into its generally “U” shape form when in use. A crease (which is one form a preferential bending location can take) can be formed in some flexible walls by simply folding the flexible wall and applying pressure, in the same way a crease is formed when folding a piece of paper. A preferential bending location can also be formed by mechanically altering the wall geometry using other operations as will be described.

In one non-limiting example, a wall is formed to a net shape (for example via a molding operation) where a preferential bending location is directly formed in the flexible wall during initial manufacture without the need to locally induce stress to exceed the elastic limit of the material. Alternatively, a thermoforming or other heating operation could be used that softens the material, so it can flow into a new shape.

Any known processing method may be used to form the preferential bending locations in the flexible wall to aid it in forming a desired shape. The desired shape may require adding only a pair of preferential bending locations as shown in FIG. 4A where the wall section has one pair of locations of a rapid change in angle over a relatively small section of the wall length. However, other more complex desired shapes are contemplated herein. Examples are not limited in the number of preferential bending locations in the flexible wall structure.

FIG. 4B depicts alternative example piecewise linear flexible wall 41 of snow wiper 40. In this non-limiting example, rigid or semi-rigid side section 44 is coupled to rigid or semi-rigid center section 45 via hinge 67 and rigid or semi-rigid side section 43 is coupled to rigid or semi-rigid center section 45 via hinge 68. Side and center sections 43, 44 and 45 can be formed from semi-rigid closed cell foam, such as EVA or cross-linked polyethylene foam, though many other materials are possible (such as polyurethane foam). Any materials that are soft enough such that they will not damage a painted vehicle surface but rigid enough to break through icy snow so it can be removed may be used and are contemplated herein. Numerous polymer foams are good candidate materials, as described above. Alternatively, rigid materials can be used for the side and center sections if a second material that is sufficiently soft so as not to damage vehicle surfaces is added to edges of the side and center sections that contact a vehicle surface in use. In one non-limiting example, HDPE sheet material ⅛″ to ¼″ thickness may be used as flexible wall sections, with a separate soft elastomer material joined to the panel to form contact edges. It should be noted that somewhat harder materials can be used for snow wipers designed to remove snow from other exposed surfaces such as the roof of a dwelling or building, or the roof of a semi tractor trailer, as those surfaces are less easily damaged compared to painted vehicle surfaces.

Hinges 67 and 68 can be formed from a soft elastomeric material. In one non-limiting example, the same material used to form hinges 204 and 205 is also used to form softer contact edges for sections 43, 44 and 45. In one non-limiting example, hinges 67 and 68 are formed as living hinges and are constructed from the same material as sections 43, 44 and 45. Hinges 67 and 68 allow wiper 40 to be formed generally into a “U” shape for use in removing snow from a vehicle surface.

The snow wiper of FIG. 4A shows simple holes in side panels acting as gripping structures, and the snow wiper of FIGS. 4B-4C does not show gripping structures. Any of the gripping structures that are described in this disclosure can be coupled to flexible walls depicted in these figures, and examples are not limited in the type of gripping structure coupled to the flexible wall. FIG. 4B depicts holes 47 in the ends of side sections 43 and 44 of flexible wall 41. These holes, while not required, can be used for coupling to gripping structures. The holes can provide an alignment feature for locating the gripping structure. In one non-limiting example, posts that are formed as part of a gripping structure fit through holes 47. In one non-limiting example, a separate post may be fit through holes in a gripping structure that are aligned with holes 47 in the flexible wall. An example depicting use of separate posts is described in more detail in a subsequent section. Example snow wipers disclosed herein are not limited in the manner in which a gripping structure is coupled to a flexible wall. Any known mechanical coupling method can be used. For example, gripping structures can be clamped over a flexible wall. Mechanical fasteners such as snaps, clips or threaded fasteners can be used. Gripping structures can be bonded to flexible walls with an adhesive or may be thermally or ultrasonically bonded to flexible wall.

FIG. 4C depicts a top view the flexible wall 41 of wiper 40 folded up for easy storage. Hinges 67 and 68 are arranged to flex sufficiently to allow panels 43, 44 and 45 to fold up flat for storage. Hinges 67 and 68 are shown bending in one direction but are not limited to bending in only this direction. Hinges could bend in the same direction or opposite directions relative to each other, so that the flexible wall can be folded up for storage.

A piecewise linear flexible wall can be thought of as an approximation to a continuous flexible wall that can be bent or shaped by a user. Where a continuous flexible wall can be rolled up into a cylindrical shape, a piecewise linear approximation of a continuous flexible wall can be rolled up into a shape that is a piecewise linear approximation of a cylinder, where the approximation improves as the number of linear sections increases. A flexible wall that is a piecewise linear approximation of a continuous flexible wall may have 3 or more separate linear sections. Examples are not limited in the number of linear sections used.

One or more mechanical properties (for example stiffness or mass) of the flexible wall of the example snow wipers disclosed herein can be varied as a function of position in the flexible wall, for example as a function of the flexible wall length. Mechanical properties can be varied by making geometrical changes (such as adding preferential bending locations as described above or by adding other structures such as ribs or making wall thickness or other geometric changes). Geometrical changes may be made in locations spanning only a portion of the flexible wall or may occur throughout the entire flexible wall. Operations such as machining or thermoforming can be used to locally change the flexible wall geometry, or the geometry can be formed in the flexible wall during initial manufacture (such as by molding or extrusion). Mechanical properties of the flexible wall can be varied by changing the material properties of the flexible wall as a function of its position or length (either by using materials with different material properties in different sections of the flexible wall, or by processing sections of the wall to locally change properties by, for example, compression molding to locally alter material density, or applying a chemical that locally alters mechanical properties of a particular material). Geometrical changes can be combined with material property changes if desired.

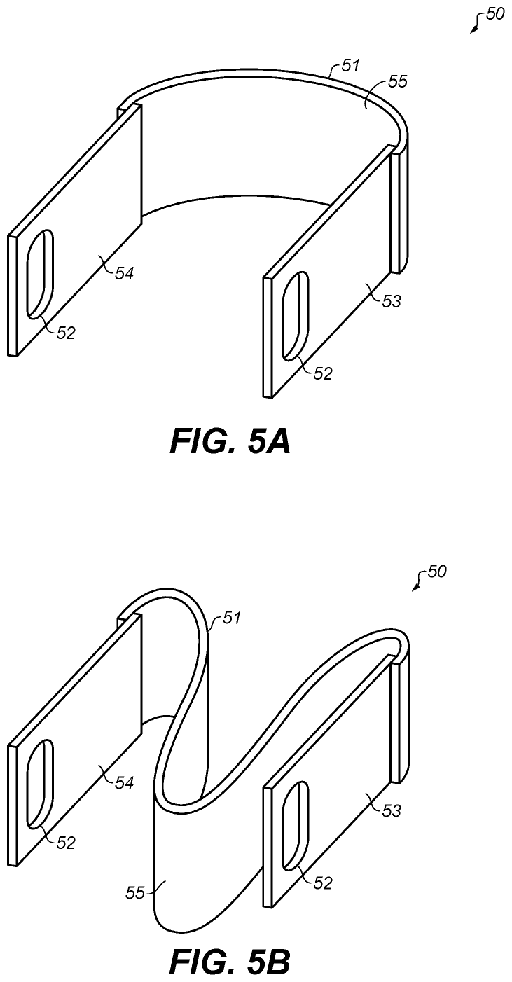

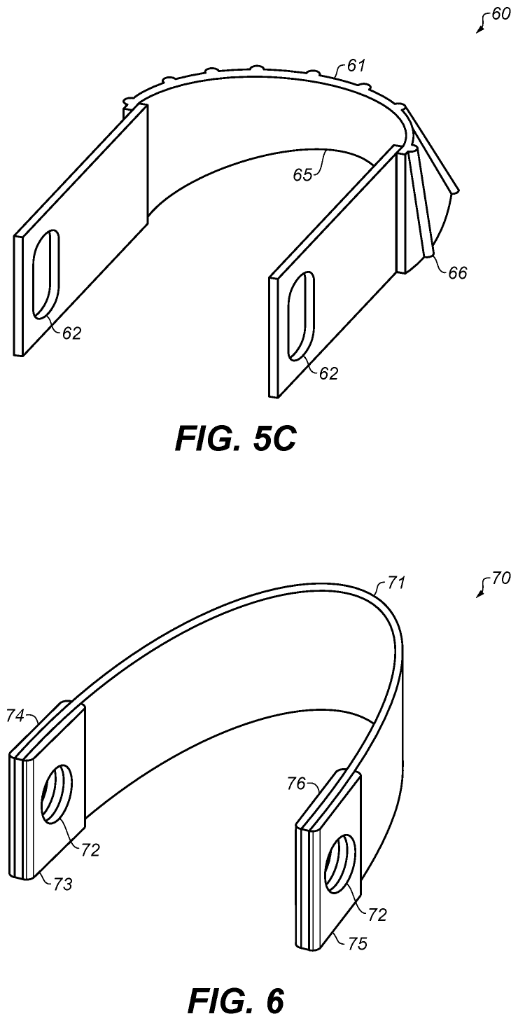

In one non-limiting example shown in FIGS. 5A and 5B, the bending stiffness of the flexible wall 51 of snow wiper 50 is varied as a function of length of or position along the flexible wall, to control the shape of the flexible wall in use. In this example, the side walls 53 and 54 are formed from a stiffer material than is the rear wall section 55. FIGS. 5A and 5B (and FIG. 5C) show side wall sections connected to rear wall sections with an overlap joint. However, wall sections can be joined using any known joining method. The flexibility of the rear wall is kept sufficient to allow it to deform in use to conform to the surface contours of the vehicle. The side walls may be formed, for example, from a polymer sheet material such as polyethylene sheet die cut to size, where the sheet thickness is approximately 0.125 inches, and a flexible center wall section can be formed from a more flexible material such as a thin sheet solid polymer material (examples may have a wall thickness between 0.020″ and 0.080″) or a somewhat thicker foamed polymer material (examples may have a wall thickness between 0.125″ and 0.5″). Foam materials used in snow wipers should be of the closed cell type to improve environmental robustness (including water resistance), though use of open cell foams is not precluded.

Examples disclosed herein are not limited in the particular materials chosen for use as the flexible wall. As long as the flexible wall is not so thick as to take up too much room when stowed away, a wide variety of materials can be used. The flexible wall can be formed from solid or foamed materials. The flexible wall can be formed from solid or foamed polymeric materials. Flexible walls can be made of plastics and polymers, elastomer or rubber, thermoplastics, and thermoset and crosslinked man-made materials. Flexible walls can be made from natural materials such as leather, natural fiber cloth or other natural materials. Flexible wall materials may be thermoplastic polyolefins, for example polypropylene, low, medium or high-density polyethylene (LDPE, MDPE or HDPE) or other known forms of polyethylene, or ethylene propylene diene monomer (EPDM) rubber, or other known thermoplastic resins. Flexible wall materials may be polyurethanes, silicone-based resins, vinyl and polyvinyl chloride, thermoplastic elastomers (TPE's), EVA foam, natural or synthetic rubbers or other polymer materials. Examples disclosed herein are not limited in the particular materials chosen for the flexible wall, so long as the materials chosen retain useful material properties in the low temperature operating region of snow wipers (materials retain flexibility down to −40 degrees C.), are resistant to UV exposure and resist cutting and tearing. Materials used in snow wipers used for vehicles also should not degrade at high storage temperatures (+85 degrees C.),

Different materials may be laminated together to form a composite flexible wall. In one non-limiting example, a printable fabric material is laminated to a foam material to provide a surface on which merchandising information or other information can be printed. Alternatively, a foam material can be used that can be directly printed on so lamination is not required.

A laminated layer can be added to improve tear strength of a composite flexible wall. In one non-limiting example, a material such as woven Kevlar fabric or Cut-Tex Pro cut resistant fabric available from PPSS Group located at: Whitfield Business Park, Unit 1, Manse Lane, Knaresborough HG5 8BS. UK is laminated to a substrate material, for example 0.20″ thick LDPE or HDPE closed cell foam, though use of a lamination layer to improve tear strength with other foams and solid polymeric materials is also contemplated.

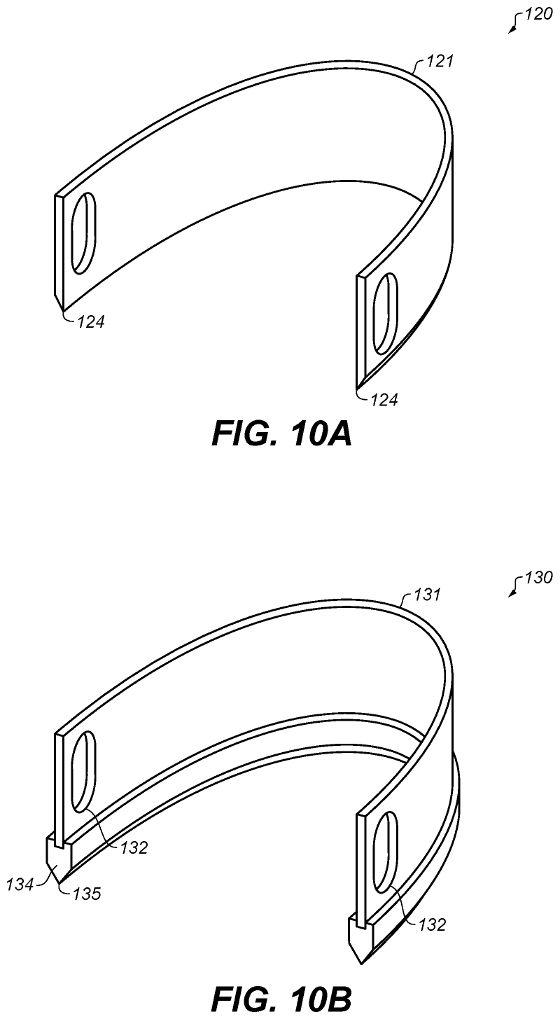

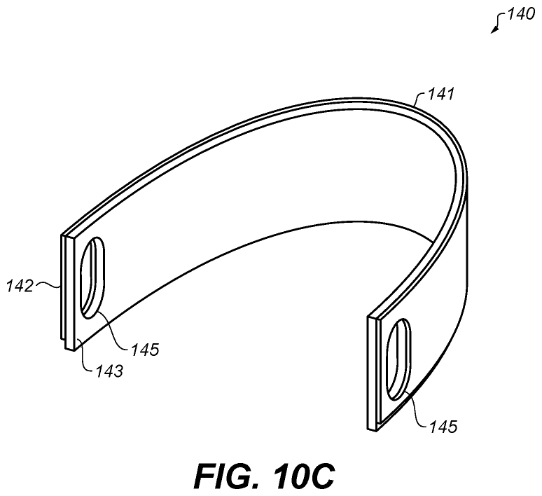

An elastomeric layer can be laminated to a stiffer, thermoplastic layer, as described in more detail with respect to FIG. 10C.

FIG. 5B depicts snow wiper 50 folded up for storage. Center section 55 of flexible wall 51 is sufficiently flexible that it can be folded up on itself without causing permanent deformation. This allows the snow wiper to fold up relatively flat. For an example snow wiper that is 6 ft. long by 6 inches high, this would allow a design to fold up into a rectangular box shape approx. 18 inches long by 6 inches high. The thickness will vary with the flexible wall thickness chosen and how tightly the unit folds up but can generally be less than 2 inches thick. In another example, end sections 53 and 54 could be made shorter and center section 55 could have more folds to alter the dimensions of the wiper when folded for storage. Center section 55 could be folded to form 4 folded portions rather than the two sections shown. In this case, the wiper could be folded into a rectangular shape approx. 12″ long by 6″ wide, with a thickness slightly larger than in the above example (the thickness would be greater by approx. 2 times the wall thickness to account for the larger number of folded sections). It should also be noted that wipers having continuous flexible walls made from a contiguous piece of material (or contiguous laminated materials) could be folded as shown. Wipers need not have stiffer side wall sections in order to be folded up into a rectangular shape. Any of the flexible walls of snow wiper designs disclosed or contemplated herein can be folded into a rectangular shape.

Other portions of the flexible wall can be made stiffer or less stiff as desired. In one non-limiting example depicted in FIG. 5C, a plurality of ribs 66 that traverse the height of the flexible wall 61 of snow wiper 60 have been added to at least center portion 65 of the flexible wall 61. The ribs 66 increase the bending stiffness of the flexible wall 61 in the height degree of freedom, while minimally affecting the bending stiffness in the length degree of freedom. Snow wiper 60 is capable of being folded up for storage in the same manner as shown for snow wiper 50 of FIGS. 5A and 5B. It should be noted that example snow wipers disclosed herein are not limited in how the stiffness of the flexible wall is altered as a function of length of or position in the flexible wall. It should also be noted that ribs can be added to any section of any of the snow wipers disclosed herein, oriented in any desired direction. The additional of vertical ribs is described with respect to FIG. 5C. In one non-limiting example (not shown), longitudinal ribs are added to the flexible wall. Longitudinal ribs can be extruded as part of producing the flexible wall material, or ribs can be formed from a separate operation such as thermoforming. Stiffness of the flexible wall can be altered by varying the cross-sectional thickness of the flexible wall as a function of wall height. In one non-limiting example, the cross-sectional thickness of the flexible wall is thickest in the middle of the flexible wall height.

Snow wipers 30, 40, 50, and 60 are shown having cutouts 22, 32, 42, 52, and 62 in flexible walls 21, 31, 41, 51, and 61 respectively, to provide gripping structures. It should be noted that all of the snow wipers depicted in FIGS. 3A-5C show simple penetrations in the flexible wall to provide gripping structures. This was for convenience only. Any of the gripping structures disclosed herein may be used with the snow wipers of FIGS. 3A-5C. Cutouts provide simple and inexpensive gripping structures and are practical solutions, especially for versions of wipers that have stiffer side walls. The cutout provides a gripping location without adding material or another component. However, penetrations in the flexible walls reduces the stiffness of the flexible wall and are less desirable in snow wipers that use more flexible materials. If penetrations are desired in a flexible wall formed from a more flexible material, an additional gripping structure should be coupled to the flexible wall in the area of the penetration to provide support for the flexible wall in the area of the penetration to resist buckling.

While simple cutouts provide openings with structure a user can wrap their hands around, other gripping structures are possible. The ends of the flexible wall can be formed into gripping structures, or material can be added to ends of the flexible walls to provide gripping structures. Rather than forming holes, sections of the flexible wall near the ends can be formed into indentations into which a user's fingers can fit. Alternatively, the ends of the flexible wall can be formed into protrusions which the user can grasp. Various manufacturing processes can be used to form gripping structures. Flexible walls made from polymeric foam or from solid polymeric material can be vacuum formed, thermoformed and/or compression molded.

Additional foam material may be laminated to a flexible substrate that forms the flexible wall. The foam material can be die cut to a final shape or can be thermoformed or compression molded to shape. Injection molding can be used to mold gripping structures around a portion of the flexible wall. The injection molded gripping structures can be made from solid polymer materials, or the material can be foamed. In one non-limiting example gripping structures can be separately formed via injection molding, and then adhered, bonded to, clamped around or otherwise physically or mechanically coupled to end sections of the flexible wall. The example snow wipers disclosed herein are not limited in the type of gripping structure used, and any snow wiper disclosed herein can be used with any known gripping structure, whether or not such gripping structure is specifically disclosed herein.

In one non-limiting example depicted in FIG. 6, die cut sections of foam 73 and 74 are laminated around one end of flexible wall 71 and die cut foam sections 75 and 76 are laminated to the other end of flexible wall 71. Holes 72 are formed in the die cut foam sections and the flexible wall, so the user can fit their fingers through the holes and grasp ends of snow wiper 70. If a more complex shape is desired, foam could be compression molded around the flexible wall ends. Foam sections 73 and 74 may be coupled to the flexible wall using a pressure sensitive adhesive (PSA) or may be heat bonded, ultrasonic welded, mechanically coupled (with snaps or any type of known mechanical fastening method) to the flexible wall. In one non-limiting example, foam sections 73 and 74 are formed from the same foam material as the flexible wall (which may be closed cell LDPE foam or EVA foam). Laminating extra foam sections to the ends of the flexible wall increases the sectional stiffness of the end sections and can compensate for a loss in sectional stiffness caused by holes 72 that penetrate through flexible wall 71. In one non-limiting example (not shown), solid pieces of foam could be laminated to flexible wall 71 without holes 72 in either flexible wall 71 or the solid foam pieces. The solid foam pieces provide a sufficient structure for gripping without the need for penetrations. A single foam piece could be coupled on each end of flexible wall 71, or a pair of solid pieces could be coupled to each end of flexible wall 71.

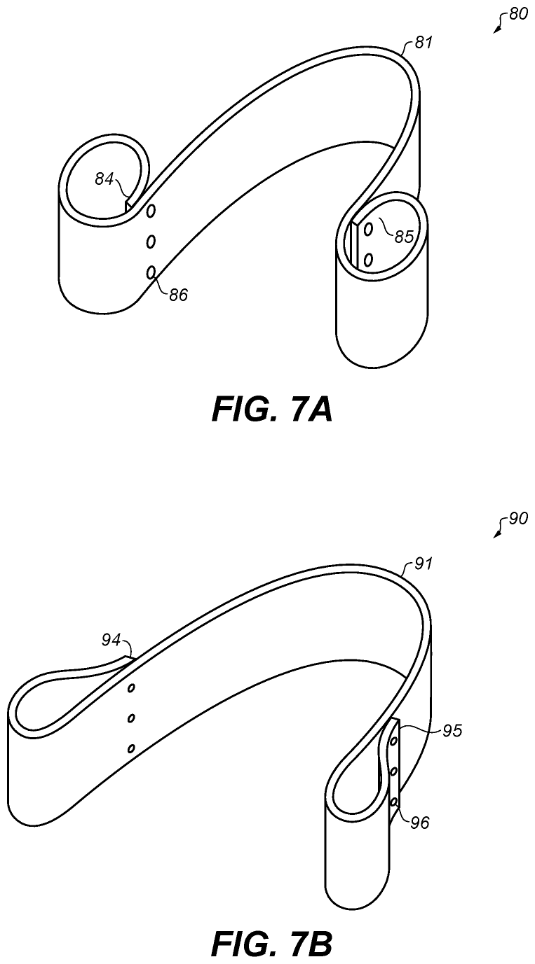

As mentioned earlier, the ends of the flexible wall can be formed into gripping structures. FIGS. 7A and 7B each depict non-limiting examples where the ends of the flexible wall are folded back onto the flexible wall to form gripping structures. In FIG. 7A, ends 84 and 85 of flexible wall 81 of snow wiper 80 are rolled inside so the ends sit in the interiors of the rolled ends. Ends 84 and 85 are fixed to locations on the flexible wall 81 approximately 3-6 inches from the ends 84 and 85 with fasteners 86. FIG. 7B depicts snow wiper 90 where ends 94 and 95 are folded back against flexible wall 91, where ends 94 and 95 sit outside of the rolled ends. Ends 94 and 95 are affixed to the flexible wall 91 using fasteners 96. The distance up the flexible wall that the ends of the flexible wall are fastened varies with the thickness of the flexible wall and the tightness of the roll formed. Fasteners 86, 96 may be snaps, clamps or ties, pop rivets, Velcro, threaded fasteners or other known fasteners. Alternatively, the ends 84, 94, 85, 95 can be fixed to flexible wall 81, 91 using an adhesive, ultrasonic welding or heat staking. Example snow wipers disclosed herein are not limited in the manner in which ends of the flexible wall are fastened to other portions of the flexible wall to form gripping structures.

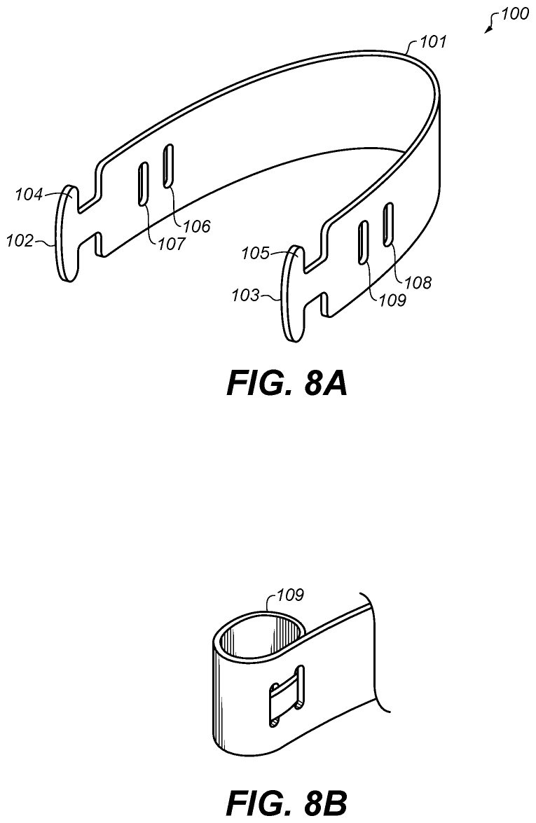

FIGS. 8A and 8B depict one non-limiting example snow wiper where the ends 102 and 103 are formed into gripping structures without the need to use fasteners as shown in FIGS. 7A and 7B. Ends 102 and 103 of flexible wall 101 have tabs 104 and 105 formed in them. Near end 102 in flexible wall 101 are slits 106 and 107, and near end 103 in flexible wall 101 are slits 108 and 109. Tab 104 is fit through slits 106 and 107, and tab 105 is fit through slits 108 and 109. FIG. 8B shows one end portion of flexible wall 101 with one end formed into cylindrical gripping structure 109 (a practical example would form both ends into gripping structures). To form gripping structure 109, tab 104 is rolled around to the outside of flexible wall and is fed first thru slit 106 and them slit 107, so that tab 104 resides in the interior of cylindrical gripping structure 109. Tab 104 could also be fit through slit 107 and then 106, but it would expose tab 104. Alternatively, in one non-limiting example only a single slit is formed in the flexible wall near each end of the flexible wall. The portion of the flexible wall near the end used to form gripping structure 109 could be pre-biased in some manner so as to alter the end shape of the gripping structure if desired. Example snow wipers disclosed herein are not limiting in the shape of gripping structure used, as long as the shape can be grasped by a user.

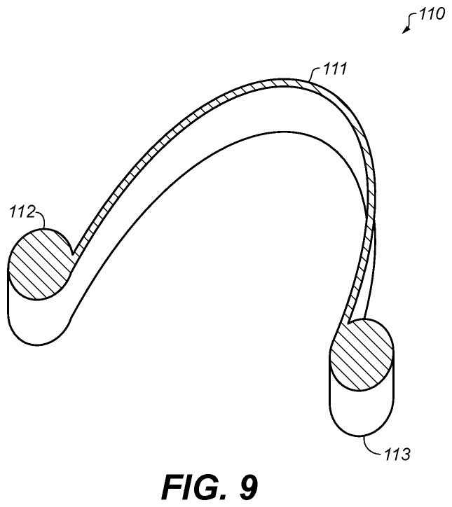

Depicted in FIG. 9 is one non-limiting example of a snow wiper where gripping structures are formed as part of the flexible wall. Gripping structures 112 and 113 are integrally formed as part of flexible wall 111. While gripping structures 112 and 113 are shown as being cylindrical in shape, this is not required, and other shapes are also contemplated herein. Any cross-sectional shape that provides a structure that aids a user in gripping the ends of the flexible wall may be used (such as half round, oval racetrack, triangular, rectangular or other more complex shapes).

All of the snow wipers depicted in FIGS. 6-9 (and also FIGS. 3-5, 10A-C, 11-14, and 16 A-C, some of whose descriptions follow) show a simple construction for the flexible wall. This was for convenience only. It should be noted that any of the flexible wall constructions and materials disclosed herein may be used with any of the snow wipers shown in these figures.

FIG. 10A depicts non-limiting example snow wiper 120. In one non-limiting example, flexible wall 121 is formed from 0.25-inch-thick ethylene-vinyl acetate (EVA) closed cell foam material, but other foam materials such as Volara cross linked polyethylene foam available from Sekisui Chemical Co. Ltd., Tokyo 105-8450 Japan, or other foams can be used. Closed cell foams are generally preferred as they are more resistant to water and humidity. Laminated foam material may also be used. A printable fabric may be laminated to one or both sides of a foam or rubber material so printing can be applied. Examples devices can be formed by cutting bulk foam materials to size. Bulk sheet foam material supplied in roll form can be slit to a desired width (the height of the flexible wall), for example 6 inches.

The thickness of the flexible wall can be reduced near the bottom edge that is placed against the vehicle surface in use, compared to the wall thickness of the flexible wall away from the bottom edge, for example near the midpoint of the flexible wall height. Having reduced wall thickness along the bottom edge of the flexible wall improves its ability to be moved through snow when the flexible wall is placed onto the vehicle surface. In the non-limiting example depicted in FIG. 10A, the bottom edge 124 of flexible wall 121 has been slit at an angle that is not perpendicular to the side walls of the flexible wall, so that the wall thickness at the bottom edge of the flexible wall has decreased. The slit may traverse the entire width of the wall section as shown (e.g. the edge may be beveled) or may only traverse a portion of the wall thickness (e.g. the edge may be chamfered to remove one bottom corner but leave the other bottom corner intact). Other ways of reducing the wall thickness near the bottom edge of the flexible wall are also contemplated herein. In one non-limiting example, foam sheet material used for the flexible wall can be compression molded to reduce the wall thickness near the bottom edge. Compression molding foam sheet material to reduce the wall thickness of the flexible wall near the bottom edge also increases the density of the wall in this region which improves the robustness of this part of the flexible wall against mechanical fatigue from contacting the vehicle surface. Alternatively, a foam flexible wall can be molded in injection molding apparatus into net shape having reduced wall thickness near the bottom edge. Though not shown, the top edge of flexible wall 121 could be formed similarly to how edge 124 is formed, so that either edge could contact the vehicle surface in use.

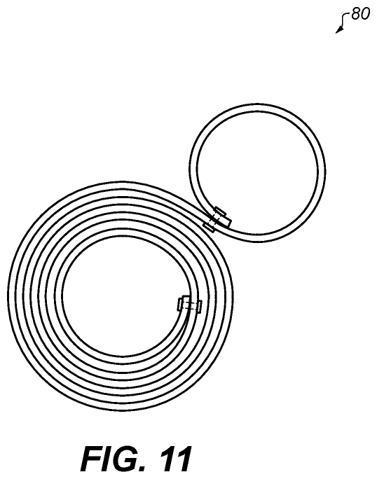

Referring again to FIG. 10A, rather than forming flexible wall 121 from foam, in one non-limiting example flexible wall 131 is formed from a material such as 0.040 inches thick solid polyethylene sheet (for example, LDPE, MDFPE or HDPE, or other known polyethylene variants). Polyethylene sheet material is harder than the foam materials previously described, but it is sufficiently flexible that it can be easily formed into a U shape when handles 132 are grasped by a user and is also sufficiently flexible that it can be rolled into a tight cylindrical shape for storage, as will be described in more detail with respect to FIG. 11. The long edges of the flexible wall may be shaped. A bevel shaped (as shown) or chamfer shaped long edge reduces the cross-sectional area of the edge. This helps the flexible wall cut through snow that may have iced over. A long edge of a flexible wall may also be radiused (not shown). A rounded or radiused edge helps reduce chatter when the flexible wall is dragged across a rough surface from which snow is removed.

Using a thin, flexible but harder sheet material such as polypropylene provides a flexible wall with a yet smaller wall thickness near the bottom edge (in this case the entire flexible wall has a small wall thickness), which improves the ability of the flexible wall to cut through snow when it is placed onto a vehicle surface. Using a thin sheet material also allows the flexible wall to be rolled into a smaller diameter cylinder than can be done using flexible wall having a thicker wall (for example 0.25-inch-thick flexible wall formed from cross linked polyethylene foam).

The thin, flexible and hard sheet, however, may not be ideal for contacting a vehicle surface to remove snow. The harder sheet material may “chatter” as it is dragged across the vehicle surface. FIG. 10B depicts edge trim 134 applied to a bottom portion of flexible wall 131, which in this example is the bottom edge of flexible wall 131. Edge trim 134 is made from a softer, flexible material, such as a thermoplastic elastomer (TPE). The edge trim performs a similar function to a windshield wiper. In one non-limiting example, a thin lip 135 extends downward for contact with the vehicle surface. This “wiping edge” allows the snow wiper to make better contact with the vehicle surface when there is some contour to the surface. Edge trims are not limited in the cross section used, however, and many shapes can practically be used. Edge trims may also be applied to both the top and bottom edges.

In one non-limiting example, edge trim 134 is a separate extruded strip material that is die cut to length and slipped over the bottom edge of the flexible wall 131. Edge trims such as model 1630SB3-1581 from Trim-Lok, Inc. with headquarters located in Buena Park, Calif., or various other similar edge trims can be used.

Rather than sliding edge trim over the bottom edge of the flexible wall, soft material for contacting the vehicle surface can be laminated to a stiffer component of flexible wall. In one example, depicted in FIG. 10C, flexible wall 141 is formed by laminating a sheet of softer material 143, such as polyethylene foam ⅛ inches thick, to a sheet of stiffer material 142, such as high density polyethylene sheet 0.030 inches thick. The foam material extends below the bottom edge of the sheet material to provide a soft surface to contact the vehicle surface. Though the soft material is shown as covering the entire face of the sheet material, this is not required. Alternatively, the flexible wall can be formed with a co-extrusion process. In this example, a polymer sheet material such as polyethylene is extruded to form the flexible wall, and an elastomeric material (a TPE, rubber, or similar material) is co-extruded to form the lower edge trim portion of the flexible wall. The materials are extruded together, and the edge trim is intimately bonded with and formed as part of the flexible wall. Although edge trim is described for use with thin, stiffer sheet materials, edge trims could also be used with a foam material if desired.

In one non-limiting example, the softer material 143 shown in FIG. 10C is a thin elastomeric layer (in this example 0.030″ thick EDPM rubber, though other elastomer materials and thicknesses may be used and are contemplated herein) which is laminated to the thin stiffer sheet material 142 (which in this example is 0.030″ thick HDPE but may be other materials and thicknesses as described previously), where the elastomeric layer along at least one long edge of the flexible wall extends slightly beyond the edge of the stiffer sheet material, so that the elastomer layer contacts the vehicle surface when the long edge is placed against a vehicle surface. The short portion of softer elastomer material extending beyond the stiffer sheet material provides a conforming edge for the wiper to improve the wiper's ability to conform to the vehicle surface while reducing chatter as the edge is pulled across the surface.

It should be noted that all of the snow wipers depicted in FIGS. 10A-10C show simple penetrations in the flexible wall to provide gripping structures. This is for convenience, and any of the gripping structures disclosed herein may be used with the snow wiper examples depicted in FIGS. 10A-10C, including structures accommodating extension poles to increase reach.

Depicted in FIG. 11 is a top view of snow wiper 80 from FIG. 7A configured for storage. Snow wiper 80 has been rolled into a generally cylindrical shape (the shape is close to cylindrical except for the one gripping structure formed as part of the flexible wall that sits on the outside of the rolled-up example device). While FIG. 11 is shown using snow wiper 80, any of the example snow wipers disclosed herein can be rolled up for storage. In one non-limiting example, the rolled-up diameter (without compressing the walls and not considering the gripping structure that sits on the outside of the cylindrical rolled up body of the snow wiper) measured at its largest point, is less than 6 inches. In one non-limiting example, the rolled-up cylinder diameter is less than 4 inches. In one non-limiting example, the rolled-up cylinder diameter is less than 3 inches.

FIGS. 12A and 12B depict use of example snow wipers by a single user and by a pair of users. The following discussion is applicable to any of the snow wipers disclosed herein. FIG. 12A depicts use of an example snow wiper by a single user. A single user grabs a first gripping structure 162 coupled to one end of the flexible wall 161 of snow wiper 160 with one hand and a second gripping structure 163 coupled to the second end of the flexible wall 161 with their other hand and bends the flexible wall of the snow wiper into a generally U-shaped form. They then reach across a vehicle 170, extend the U-shaped snow wiper over the vehicle 170 and place snow wiper 160 down against the vehicle surface so that the open end of the “U” faces toward the user. Once in place against the vehicle surface, the user may alter their hand position and force application to alter the contour of the bottom edge of the flexible wall 161 to better fit the surface contour of the vehicle. Then the user pulls the snow wiper back towards their body in the direction of the arrow to pull snow off the vehicle.

As shown in FIG. 12B, example snow wipers disclosed herein can also be used by two people. Flexible wall 161 of snow wiper 160 is shown having a length that spans the width of horizontal surfaces of the vehicle 170. The flexible wall 161 is straightened out to extend across the width of the vehicle 170. A first gripping structure 162 is held by a first user (not shown) standing alongside a first side of the vehicle and a second gripping structure 163 is held by a second user (not shown) standing alongside the other, opposite side of the vehicle. The two users can vary their hand positions and angles, and the direction in which they apply force to the snow wiper 160 to alter the contour of the bottom edge of the flexible wall 161, to better fit the surface contour of the vehicle 170. The two users can then pull the snow wiper 161 across the vehicle 170 along its length to remove snow. With this arrangement it is possible to remove substantially all of the snow present on the major horizontal surfaces of the vehicle 170 (the hood, front and rear windshields, roof and trunk lid) in a single pass. The effectiveness of example snow wipers disclosed herein is greatly improved compared to traditional snow brushes and brooms. The extended flexible wall, whether formed into a “U” shape to be used by a single user or extended across a vehicle when two users are available, is capable of removing substantially more snow in a single pass than can conventional snow brushes.

In one non-limiting example, a flexible wall is formed from solid polyethylene sheet material. This construction is applicable to all of the snow wipers disclosed herein. In this example, the flexible wall is 36″ long by 6″ wide, though other lengths and widths are also contemplated herein. Lengths between 24″ and 60″ have been found to work well. The thickness is chosen to be 0.040″. However, wall thicknesses between 0.020″ and 0.080″ have been found to work well. Thinner material has reduced sectional stiffness resulting in the flexible wall buckling more easily, making the wiper more difficult to use. Flexible walls formed from solid polymer material thicker than 0.080″ thick may also work, though additional thickness adds extra mass and cost. Examples are not limited in the chosen dimensions, as discussed earlier.

A flexible wall formed of solid polyethylene sheet material (preferably MDPE but may be LDPE, HDPE or other forms of polyethylene) is fairly inexpensive yet possesses good environmental performance (both MDPE and LPDE sheet maintain ductility at low temperatures, have softening temperatures above maximum expected automotive use temperatures, and have good chemical resistance) and useful mechanical properties (MDPE and LPDE materials are strong and tear resistant and have sufficient internal damping to avoid chattering when a snow wiper is pulled across a vehicle surface). MDPE has been determined to be a beneficial material, though other polymer materials as described earlier may be used. The internal damping behavior of MDPE and higher stiffness compared to LDPE allow it to be used alone for the flexible wall of a snow wiper without the need to add a wiping edge for better surface conforming (for example, made from a TPE material as described in a subsequent section) or to add additional structures to add stiffness to the flexible wall to allow it to cut through icy snow.

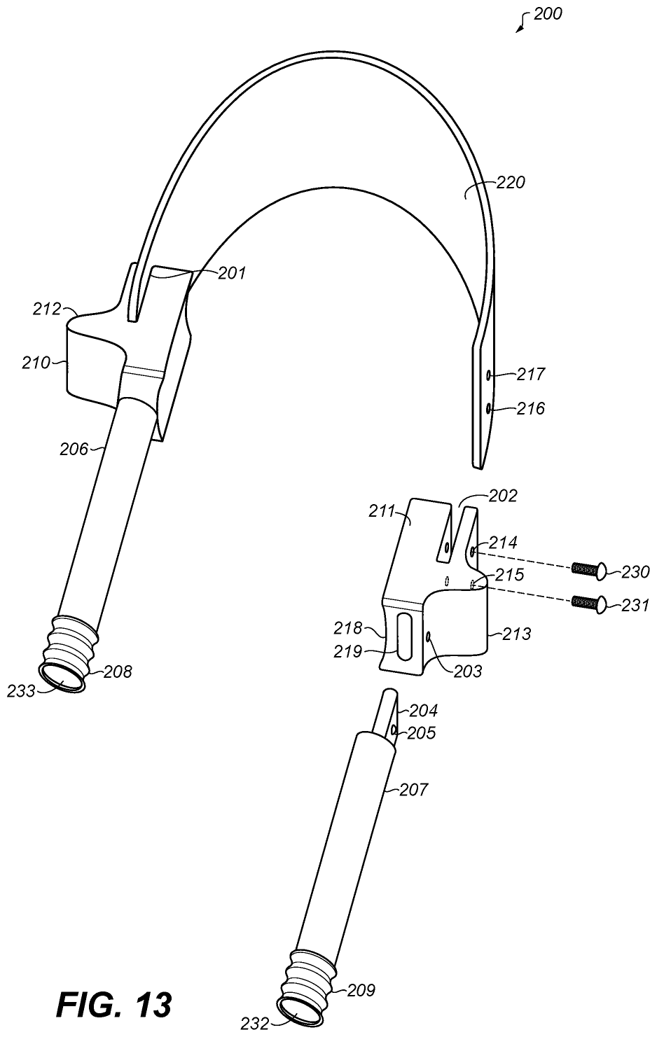

In one non-limiting example depicted in FIG. 13, snow wiper 200 is composed of flexible wall 220, structures 210 and 211 which are coupled to ends of flexible wall 220, and optionally includes extension poles 206 and 207. Extension poles 206 and 207 may include hand grips 208 and 209. Structures 210 and 211 act as coupling structures to couple extension poles 206 and 207 to flexible wall 220, and also act as gripping structures that allow a used to grasp the snow wiper when extension poles 206 and 207 are not present. FIG. 13 depicts one end of snow wiper 200 fully assembled where structure 210 is coupled to flexible wall 220, and extension pole 206 is coupled to structure 210. On the second end of snow wiper 200 the assembly is exploded to show the component parts in more detail. The components that couple to each end of the flexible wall are identical, so only the exploded components will be discussed in detail.

In this non-limiting example, flexible wall 220 is a continuous type flexible wall where bending is distributed over the length of the flexible wall. Flexible wall 220 can be formed from MDPE sheet material (a 50-50 blend of LDPE and HDPE) 0.040″ thick. However, use of any of the materials disclosed herein for use with flexible walls is contemplated for use in this example. Materials used for flexible walls should be soft enough such that they will not damage a painted vehicle surface but rigid enough to break through icy snow so it can be removed, though in some examples edges that contact surfaces to be cleared are formed from a softer material that will not damage the surface while the remainder of the flexible wall is formed from a stiffer material that improves the ability of the flexible wall to clear away icy snow.

Structures 210 and 211 may act as both coupling structures for coupling extension handles to the flexible wall 220 and as gripping structures. Ridges 212 and 213 formed in structures 210 and 211 provide a feature that a user's fingers can grasp easily. As shown in FIG. 13, one end of flexible wall 220 fits into slot 202 in structure 211. Holes 216 and 217 in the end of flexible wall 220 align with holes 214 and 215 in coupling structure 211 when flexible wall 220 is inserted in slot 202. Plugs 230 and 231 are inserted through holes 214 and 215 and are pushed through mating holes 216 and 217 in flexible wall 220. Holes 214 and 215 may continue through the slot 202 of structure 210 such that the hole is present on either side of slot 202. Holes 214 and 215 may continue through the entire structure 211 or may be blind on one side and not pass all the way through back surface 218 of structure 211. Plugs 230 and 231 traverse slot 202 and seat in portions of holes 214 and 215 on both sides of slot 202, to lock flexible wall 220 in place. Flexible wall 220 is shown locked in place in slot 201 of structure 210. In this case, plugs inserted into mating holes in structure 210 are not visible in the view as the holes in structure 210 are blind and do not extend all the way through the back wall of structure 210.

Extension pole 207 has a necked down section 204 at one end that fits into opening 219 of structure 211 allowing extension pole 207 to be removably coupled to structure 211 (a necked down section of extension pole 206 is not visible as it is shown inserted into structure 210, but it should be noted that extension pole 206 is removably coupled to structure 210). Spring loaded button 205 protrudes from the wall of section 204 and snaps into hole 203 of structure 211 when extension pole 207 is properly seated in structure 211 locking it in place (the spring button and hole associated with extension pole 206 and structure 210 are not visible FIG. 13). Pressing the spring-loaded button allows the extension pole 207 to be easily removed from structure 211. Grip 209 is located on extension pole 207 opposite the end with necked down section 204. Grip 209 may be formed as a molded or extruded foam tube that is slid over the end of extension pole 207 (grip 208 is similarly formed and located on extension tube 206).

Openings 232 and 233 in the ends of extension poles 207 and 206 can accept additional extension poles if present. A second set of extension poles can further increase the reach of a user when using snow wiper 200. Having multiple extension poles allows the user's reach with the snow wiper to be substantially increased. Use of removably coupled extension poles allows easy disassembly of the snow wiper to allow it to store away in smaller spaces such as a vehicle passenger compartment without getting in the way.

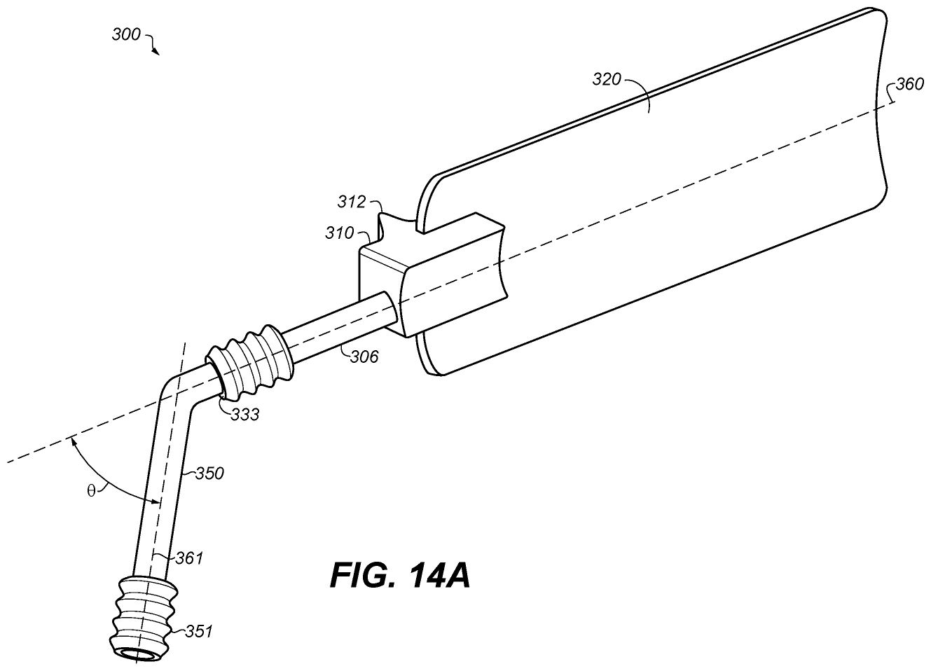

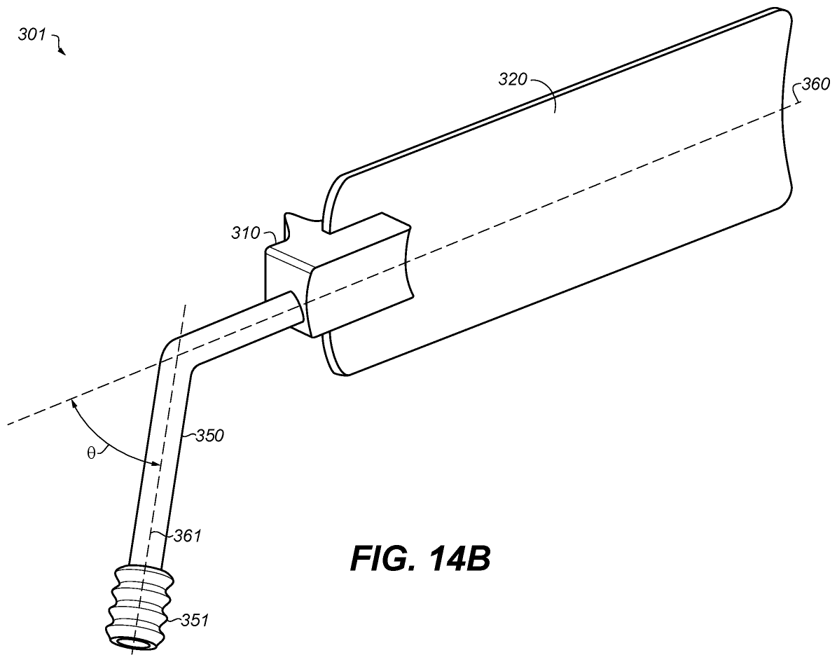

FIG. 14A depicts use of a second set of extension poles for use with snow wiper 300. Structures are shown only coupled to one end of the flexible wall 320, and flexible wall 320 is shown extended out straight, not bent into a U shape as shown in previous figures. This is for convenience only and it should be understood that when used, snow wiper 300 will have similar sets of structures coupled to both ends of flexible wall 320, and the flexible wall can be bent into a U shape by a user as needed. In the non-limiting example depicted in FIG. 14A, structure 310 is coupled to flexible wall 320. Structure 310 includes ridge 312 useful for a user to grasp snow wiper 300 if extension poles are not present. First extension pole 306 is coupled to structure 310. The details of coupling are not shown but may be similar to the exploded view of FIG. 13. Additionally, extension pole 350 is removably coupled into end 333 of extension pole 306, further increasing reach.

Centerline 360 is a geometrical construct that bisects flexible wall 320 along its length. Extension pole 350 is shown with a bend where a central axis 361 of the gripping section 351 of extension pole 350 is at an angle θ relative to the flexible wall centerline 360. A wide range of angles θ is possible, and snow wipers disclosed herein are not limited in the actual angle θ formed. Angles θ anywhere from 0 degrees (e.g. gripping section 351 of extension pole 350 is aligned with extension pole 306, which is further aligned with centerline 360) to 90 degrees are contemplated herein. It has been found that angles between about 15 and 30 degrees are particularly useful when using a snow wiper to clear a horizontal surface located above a user's head, such as a vehicle roof. In one non-limiting example, the angle θ can be adjusted by a user to best accommodate their height and the height of the roof of a vehicle from which snow is to be cleared. In one non-limiting example, the angle θ can be varied continuously over a range (such as between 0 and 90 degrees) or can be adjusted in fixed increments.

FIG. 14B depicts snow wiper 301 where extension pole 350 is directly coupled to structure 310, rather than coupling to extension pole 306. This provides the benefit of incorporating the angle θ but only uses a single extension pole which is useful for vehicles with lower roof heights. It should also be noted that rather incorporating a bend in the extension pole, the angle of the coupling of a straight extension pole to structure 310 could be varied directly.

It can be seen that structures 310 and a corresponding structure coupled to the opposite end of flexible wall 320 (not shown), and 210 and 211 of FIG. 13 form the ends of flexible walls 220, 320 in a slightly curved shape. The flexible wall is curved about a lengthwise centerline of the flexible wall (shown as centerline 360 in FIGS. 14A and 14B but not shown in FIG. 13). The curve extends over the height dimension of the flexible wall as opposed to the “U” shape bend described earlier that curves the flexible wall about a central axis that bisects the flexible wall and is perpendicular to the lengthwise centerline. Holding the ends of the flexible wall in a curve help keep the flexible wall from buckling or bending over when the entire snow wiper is lifted by structures 210 and 211, 310 or by the extension poles coupled to these structures. The amount of curvature used is not limited. In general, less stiff flexible walls may benefit from structures that impart more curvature to the ends of the flexible wall. However, it should be understood that curvature is not required and coupling and gripping structures may be used that impart zero curvature to the ends of flexible walls.

Snow wipers 200 and 300, as well as other snow wipers disclosed herein can fold or roll up for easy storage. In one on-limiting example, extension poles are removed from coupling structures, and the flexible walls with attached coupling structures (210, 211, or 310 and its corresponding structure which was not shown) are rolled or folded up. A bag or pouch can be provided to hold the folded or rolled up flexible wall assembly.

In one non-limiting example, the extension poles 206, 207, 306 (and its corresponding extension pole not shown) are permanently coupled to structures 210, 211, 310 (and the corresponding coupling structure not shown). In this example, the flexible wall is removably coupled to the structures 210, 211, 310 (and the corresponding structure). This allows the flexible wall to be easily removed and separately stored. The flexible wall without attached structures can be folded or rolled up for storage more compactly than if the structures remain attached. However, the extension poles may take up more space when they are stored with the structures coupled to the extension poles. Examples disclosed herein contemplate either construction, and may also possibly allow a user to decide whether to remove the flexible wall from coupling structures that remain attached to extension poles for storage, or to keep the flexible wall coupled to structures but remove the structures form extension poles for storage.

It should be understood that although extension poles are shown used with the snow wipers depicted in FIGS. 13 and 14, extension poles can be used with any of the snow wipers disclosed herein, including snow wipers that use either continuous or piecewise linear flexible walls. Extension poles can be used with any type of snow wiper and any type of flexible wall.

With reference again to FIGS. 13 and 14, flexible walls 220, 320 are shown extending beyond the height of coupling structures 210, 211 and 310. This not required. Either the heights of the coupling structures could be increased, or the flexible wall heights could be decreased. The flexible wall height may be decreased in the region where the coupling structures are located and may increase elsewhere. In one non-limiting example, the top and bottom long edges of the flexible wall are constrained by portions of the structures such that structures are coupled to the flexible wall over its entire height. The span of the coupling structures relative to the height of the flexible wall is not constrained and snow wipers disclosed herein may have any relationship between the height of the structures and the height of the flexible wall. The flexible wall can extend beyond the boundaries of the coupling structures in the height dimension, as shown in FIGS. 13 and 14, or it could be fully contained within the boundaries of the coupling structures.

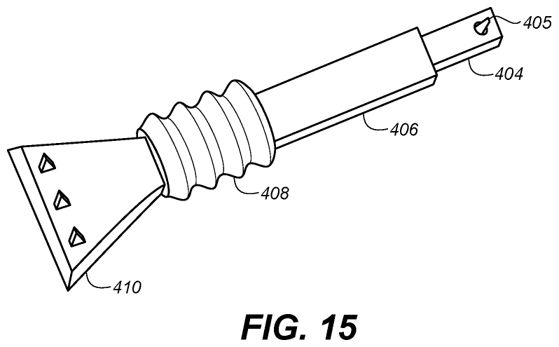

FIG. 15 depicts an alternative extension pole 406. Extension pole 406 is essentially the same as extension pole 206 with the addition of a frost and ice scraper 410 coupled to one end of extension pole 206. In the example of FIG. 15, frost and ice scraper 410 snaps into a hole in the end of extension pole 406. Providing a frost and ice clearing device on one end of the extension pole provides a snow wiper with frost and ice clearing capability. A second extension pole (not shown in FIG. 15) can be coupled to the smaller cross section end 404 of extension pole 206 via spring button 405 which would snap into a mating hole in the second extension pole, to provide increased reach for frost and ice clearing.

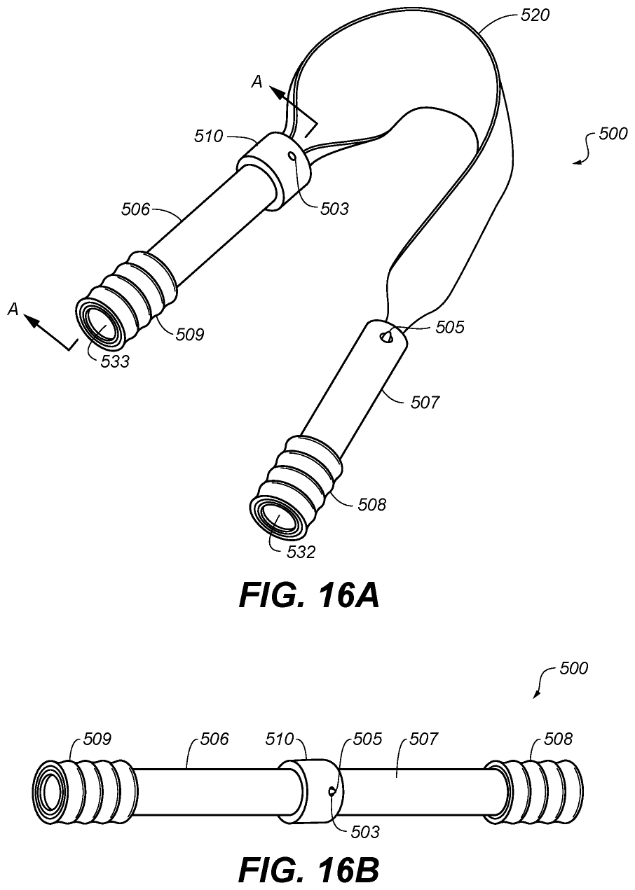

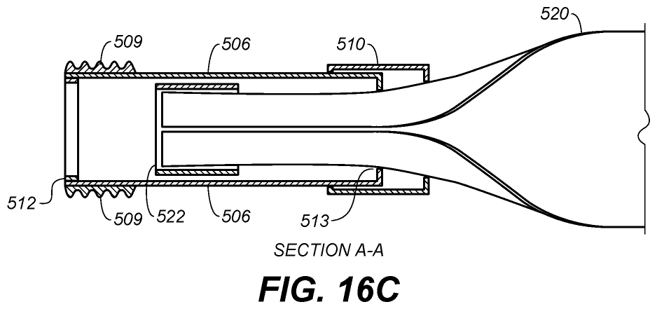

In one non-limiting example depicted in FIGS. 16A-C, a snow wiper is rolled up into a cylindrical shape about an axis aligned with the length dimension of the flexible wall. FIG. 16A depicts snow wiper 500 in an extended state with flexible wall 520 formed by a user into a general “U” shape used for clearing snow. Flexible wall 520 is coupled between first handle section 506 and second handle section 507. The internal structure is depicted in more detail in FIG. 16C. Handles 506 and 507 have grips 509 and 508 attached respectively. A user grasps grips 509 and 508 in their hands and extends the flexible wall 520 over a surface to be cleared, and then pulls the handles toward their body to remove accumulated snow from the surface.

At least one of handles 506 and 507 may have a hole in the end opposite the end the flexible wall 520 extends through. In FIG. 16A, hole 533 is located in handle 506 and hole 532 is located in handle 507 (though it should be noted that only a single hole is needed to accommodate a frost and ice scraper). Either hole 532 or 533 can accommodate a frost and ice scraping structure (such as structure 410 shown in FIG. 15) which can be snapped into the hole adding frost and ice scraping capability to the snow wiper. Handle 506 also incorporates coupling structure 510 for coupling handles 506 and 507 together. Structure 510 includes hole 503 for accepting spring loaded button 505 that is incorporated into handle 507.

FIG. 16B depicts snow wiper 500 in a closed state. This state is useful for frost and ice scraping (when a frost and ice scraping structure is coupled to either handle 506 or 507) and for storage. Flexible wall 520 is rolled up into a lengthwise cylinder and fits inside the ID of handles 506 and 507 (it should be noted that handles 506 and 507 are formed as hollow tubes). Snap button 505 aligns with and extends up through hole 503 locking the two handles in place. The length of the flexible wall that can be accommodated is constrained by the length of the handles. In one non-limiting example, handles 506 and 507 are 18″ long and flexible wall 520 is slightly less than 36″ long so that the flexible wall can fit inside the pair or tubes coupled together. In one non-limiting example, the height of flexible wall 520 is constrained by the ID of tubes 506 and 507. It is desirable for the long edges of the flexible wall 520 not to overlap each other when the flexible wall is rolled up lengthwise and fit inside handles 506 and 507. This means the height of the flexible wall should be less that the inner circumference of handles 506 and 507. Overlapping increases force needed to close up the two tubes. However, it is not required that there be no overlap. When overlap occurs, while more force may be needed to close up the two handles from an extended state, it is possible.

FIG. 16C shows a cutaway view about section A-A of snow wiper 500 (the location where section A-A is taken is shown in FIG. 16A). One half of handle 506, grip 509, coupling end 510 and sliding coupler 522 have been cut away. Sliding cylindrical coupler 522 sits inside tube 506. When snow wiper 500 is in a closed state, sliding coupler 522 sits at the end of tube 506 where grip 509 is located. A stop 512 is located at the end of handle 506 to keep sliding coupler 522 from exiting the handle end. In one non-limiting example, this stop may be provided by an end plug that is inserted into handle 506, and a similar stop can be provided in the end of handle 507 by a frost and ice scraper inserted into the tube end (or by a second end plug if a frost and ice scraper is not present). On the opposite end of handle is stop 513 which keeps sliding coupler 522 from exiting this end of the tube. The end of flexible wall 520 is fixed to the sliding coupler. In this example, the flexible wall 520 is shown sitting on the ID of sliding coupler 522 but it can also be fixed to the OD of sliding coupler 522.

A number of implementations have been described. Nevertheless, it will be understood that additional modifications may be made without departing from the scope of the inventive concepts described herein, and, accordingly, other embodiments are within the scope of the following claims.

What is claimed is:

1. An apparatus for removing snow from an exposed surface comprising:
a flexible wall,
a first gripping structure coupled to a first end of the flexible wall,
a second gripping structure coupled to a second end of the flexible wall,
wherein the flexible wall is constructed and arranged so that a user can form it generally into a “U” shape.

2. The apparatus of claim 1 wherein the exposed surface is part of a vehicle.

3. The apparatus of claim 1 wherein the gripping structures are separate structures that are affixed to the flexible wall.

4. The apparatus of claim 1 wherein the flexible wall is piecewise linear, wherein the piecewise linear flexible wall comprises first and second side sections and a center section, wherein the first and second side sections are coupled to the center section.

5. The apparatus of claim 4 wherein the first and second side sections are coupled to the center section via first and second hinge joints.

6. The apparatus of claim 1 wherein the first and second ends of the flexible wall are formed into a curved shape by the gripping structure.

7. The apparatus of claim 1 wherein the flexible wall comprises stiffening ribs.

8. The apparatus of claim 1 wherein the flexible wall is characterized by a height, wherein the height can vary as a function of position along the flexible wall.

9. The apparatus of claim 1 wherein the flexible wall is constructed and arranged so that a user can roll up the flexible wall for storage.

10. The apparatus of claim 9 wherein the flexible wall is rolled up about a height dimension into a cylindrical shape.

11. The apparatus of claim 9 wherein the flexible wall is rollable into a cylindrical shape about a length dimension of the flexible wall.

12. The apparatus of claim 1 wherein the flexible wall is constructed and arranged so that a user can fold up the flexible wall into a generally rectangular box shape for storage.

13. The apparatus of claim 1 wherein the flexible wall comprises foam.

14. The apparatus of claim 1 wherein the flexible wall comprises solid polymeric material.

15. The apparatus of claim 14 wherein the solid polymeric material has a thickness of between 0.020 and 0.080 inches.

16. The apparatus of claim 1 further comprising first and second extension poles for removably coupling to the first and second gripping structures.

17. The apparatus of claim 16 wherein the length of the flexible wall is in a range of between 2 feet and 5 feet.

18. The apparatus of claim 16 wherein the extension poles comprise griping sections, wherein the extension poles are bent at an angle so that the gripping sections of the extension poles are oriented at an angle relative to a lengthwise centerline of the flexible wall.

19. The apparatus of claim 16 further comprising a frost and ice removing structure coupled to one end of the first or second extension poles.

20. A method of removing snow from a vehicle comprising:
holding, by a user's first hand, a first gripping structure located near a first end of an elongated flexible wall,
holding by the user's second hand a second gripping structure located near a second end of the flexible wall,
forming the flexible wall into a generally U-shaped form,
extending the U-shaped flexible wall onto a vehicle surface with the opening of the U facing the user, and;
pulling the U-shaped form towards the user to remove snow from the vehicle.

21. The method of claim 20 wherein the first gripping structure further comprises a first extension pole, wherein the user grasps the first extension pole with their first hand, and wherein the second gripping structure comprises a second extension pole, wherein the user grasps the second extension pole with their second hand.

22. A method of removing snow from a vehicle comprising:
holding by a first user a first gripping structure located near a first end of an elongated flexible wall, the first user situated alongside a first side of the vehicle,
holding by a second user a second gripping structure located near a second end of the elongated flexible wall, the second user situated alongside a second side of the vehicle opposite the first side,
extending the flexible wall across the vehicle surface to span the width of the vehicle, and;
pulling the flexible wall along a portion of the length of the vehicle across the vehicle surface by the first and second users, to remove snow from the vehicle.
